(19) United States
(12) Patent Application Publication
(10) Pub. No.: US 2012/0208700 A1
(43) Pub. Date: Aug. 16, 2012

(54) STABLE AGROCHEMICAL OIL DISPERSIONS

(75) Inventors: Derek J. Hopkins, New Plymouth (NZ); Franklin N. Keeney, Carmel, IN (US); Lei Liu, Carmel, IN (US); Kuide Qin, Westfield, IN (US)

(73) Assignee: DOW AGROSCIENCES LLC, Indianapolis, IN (US)

(21) Appl. No.: 13/025,412

(22) Filed: Feb. 11, 2011

(51) Int. Cl. A01N 43/90; A01P 7/04; A01P 13/00; A01P 3/00; A01N 43/653; A01N 43/40

(52) U.S. Cl. 504/241; 514/259.31; 514/383; 504/274; 514/341; 504/253; 514/357; 504/244

(57) ABSTRACT

The present disclosure relates to the use of dibenzylidene sorbitol or derivatives of dibenzylidene sorbitol as rheology additives to provide stability to oil dispersion formulations of agrochemical active ingredients.

### FIELD OF THE INVENTION

This disclosure concerns the use of dibenzylidene sorbitol (DBS) or chemical derivatives of DBS as rheology modifiers useful in preparing stable oil dispersion (OD) compositions of agrochemical products.

### BACKGROUND AND SUMMARY OF THE INVENTION

An agrochemical active ingredient, such as a herbicide, insecticide, or fungicide, or a herbicide safener, can rarely be used in its originally manufactured form. Agrochemical products generally consist of two parts, the active ingredient and the co-formulants or inert ingredients combined together in a formulation. The combination of these two parts into the final product is conducted with two primary goals in mind: (1) maintaining the stability of the product during storage and (2) providing an easy and effective way to use the product upon dilution in a carrier such as water or oil, and spray application to an area to be treated.

Agrochemical formulations are generally designed based on customer needs and the physiochemical properties of the active ingredient(s), for example, the solubility of the active ingredient in water and other non-aqueous solvents. There are two major categories of formulations, solid formulations and liquid formulations. Liquid formulations include emulsifiable concentrates (EC), suspension concentrates (SC), soluble liquids (SL), liquid flowables (F) and oil dispersions (OD). EC formulations consist of oil-soluble active ingredient(s) dissolved in non-aqueous solvent(s) to which are added emulsifying agents.

The basic components of an agricultural OD formulation are the solvent or oil phase and the dispersed solid phase. These basic components may include active ingredients, petroleum or naturally derived solvents, safeners, rheology additives, emulsifiers, dispersants and other co-formulants that help deliver the desired attributes of the product. Rheology additives provide physical stability to the formulation by increasing the viscosity of the liquid phase in order to prevent insoluble active ingredient particles from falling out of suspension and forming a layer at the bottom of the storage container. This phenomenum, known as sedimentation, can result in difficulties in the delivery and use of the product if the sedimented layer of particles forms a hard pack that is difficult to disperse and re-suspend. A related physical instability of liquid formulations is syneresis. Syneresis in an OD formulation is generally measured as the amount of top-clearing due to phase separation.

The amount and severity of sedimentation that occurs in an OD formulation over time may be measured with a pourability test. This test is conducted by pouring the OD formulation out of a container in a controlled manner and measuring the amount of the formulation remaining in the container. The pourability value is the per cent by weight of material remaining in the container.

Rheology additives used to control sedimentation, also known as thickeners, anti-caking agents, viscosity modifiers or structuring agents, generally provide the increased viscosity to the OD formulation. In addition to increasing the viscosity of the OD formulation, rheology additives have a shear thinning capability that allows the gel network they form to easily breakdown upon application of a small external force. This shear thinning allows the OD formulation to maintain its viscosity and physical stability while at rest, but allows this viscosity to quickly dissipate when external force is applied so that the product can be easily poured or pumped from its container, mixed in a carrier such as water and applied to an area where it is needed.

Rheology additives used in products today to add viscosity come in many forms and chemistries. They can be mineral or derived from minerals (e.g., organoclays, fumed silica), swellable polymers (e.g., polyamides or hydrogenated caster oils), associative thickeners which form structures by themselves (e.g., EO/PO block co-polymers), or they can be steric dispersants (e.g., comb polymers such as polyvinylpyrrolidinones or polyacrylates). These rheological or structuring agents provide long term stability when the product is at rest or in storage.

Agrochemical products generally have to be diluted and properly dispersed in water prior to application. An emulsifier system may be included in the OD formulation to help disperse the oil-based, water immiscible formulation in water. An emulsifier system commonly includes a mixture of non-ionic and anionic surfactants in order to accommodate variations in water hardness and temperature encountered in various locations.

For polar interactions, clays, organoclays such as bentonite, hectorite or gibbsite clays, which are also known as hydrophobically modified clays, hydrogenated castor oils, castor oil derivatives, polyamides, polar, oxidized waxes, and hydrophobized fumed silica may be used as rheology aids in non-aqueous solvents. For controlled pigment flocculation in paints, organic sulfates are commonly used. High molecular weight polymers such as ethyl cellulose, cellulose acetobutyrate and man-made polymers such as polyacrylates, polystyrenes and polyisobutylenes may also be used to build viscosity in organic solvents. Finally, soaps such as aluminum stearate and magnesium stearate may be used to build viscosity.

Natural clay products are generally layered silicates that can be effective thickeners for a wide range of applications. In order to make them dispersible in non-aqueous solvents, however, the clay surface is usually treated with quaternary ammonium. These modified clays are known as organoclay thickeners. These strongly agglomerated particles need to be wetted first and then separated by shear forces. High shear mixing is desirable for this process. Activators like alcohols can penetrate in between the clay layers and help make them form loose stacks for ease of application. The typical rheology curve of clay particle modified OD formulation shows strong shear-thinning and thixotropic behavior. At low shear stress, the clay structure may show some resistance to the flow. With increasing shear stress, the applied shear force progressively destroys the clay network and the layered clay particles start to move with the flow. When the shear is removed, the clay network reforms and the viscosity builds up again. Depending on the type and origin of the clay products, it is important to know that the rheology building efficiency varies due to the difference in clay particle sizes and shapes. Boehmite clay seems to be more effective in enhancing the rheology properties of a fluid than the other type of clays due to its larger aspect ratio and hence its surface area.

The thickening mechanism of hydrogenated castor oils and their derivatives, polyamides and polar, oxidized waxes is based on hydrogen bonding, but these additives may be somewhat sensitive to temperature effects. The procedure of activating hydrogenated caster oil products requires both shear mixing and heat since these products are delivered as micronized powders. Similar to the organo-clays, these micronized powders have to be dispersed into a gel form without complete dissolution in the solvent. The first step is swelling of the crystalline particles by the solvent using shear and heat to provide swollen particles that become fully separated and dispersed. The activating temperature is dependent on the solvent type. Care has to be taken not to exceed the activation temperature otherwise the castor oil derivatives will completely dissolve, lose their thickening properties and recrystallize upon cooling. Usually a pre-gel can be made for easier use of these materials.

The third type of rheology modifiers that require polar interactions to build up a three-dimensional network are those based on fumed silica. Fumed silica, either hydrophilic or hydrophobic, is composed of nano-size primary silica particles connected together to form chain shaped segregates. Due to its extremely high surface area and wide solvent compatibility, fumed silica products are widely used in formulating industrial and consumer products. Although both hydrophilic and hydrophobic fumed silica can be used in OD formulations as thickening agents, hydrophobic silica generally provides rheology properties that are easier to control in non-aqueous formulations than does hydrophilic silica.

Rheology additives used in OD formulations to insure that suspended particles of active ingredients are not susceptible to irreversible sedimentation, may be used alone or in combination with other rheology additives. It is very common to combine one or more theology additives in a single OD formulation to obtain the desired rheological properties and, at the same time, minimize any adverse interactions that may occur between ingredients. The proper choice and amounts of OD thickeners can enhance the thickening efficacy and application range of a particular formulation. Factors to consider in the selection of rheology additives for the design of a stable OD system are the type of solvent, the interactions with emulsifiers, the robustness in activation of the thickeners, and the temperature sensitivity of the final system.

While there are many rheology modifiers available for use in stabilizing agrochemical OD formulations to particle sedimentation, there is a constant need for new ones owing to limitations with existing choices, incompatibilities with surfactants, and the diversity in chemistry of new active ingredients and solvents being discovered and developed today. In addition, the increasing number of active ingredients included in a single formulation can also present formulation challenges. These limitations may be overcome by finding new rheology modifiers that act in new ways or at lower concentrations.

Dibenzylidene sorbitol (DBS; CAS 32647-67-9 and 19046-64-1) has the following structure

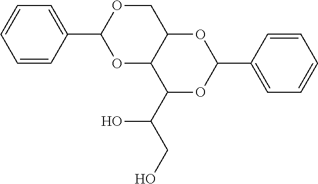

and is an organic molecule capable of inducing gelation or thickening in a variety of organic solvents. DBS is derived from the sugar alcohol D-glucitol and benzaldehyde and is marketed by Milliken Chemical as Millithix® 925s. DBS has been investigated for use as a gelling agent in personal care products such as antipersperants and cosmetics, and also in biomedical materials and electronic devices. DBS has also seen use as a clarifying agent for polyolefin derived plastics (Millad® 3905). The morphological characteristics of DBS have been described by D. J. Mercurio and R. J. Spontak in, “Morphological Characteristics of 1,3:2,4-Dibenzylidene Sorbitol/Poly(propylene glycol) Organogels,” J. Phys. Chem. B, 105 (11) pg. 2091-2098 (2001).

Two simple analogs of DBS, known as methyl-DBS (CAS 54686-97-4) and dimethyl-DBS (CAS 135861-56-2, Millad® 3988), are also available from Milliken Chemical and their respective structures are shown below

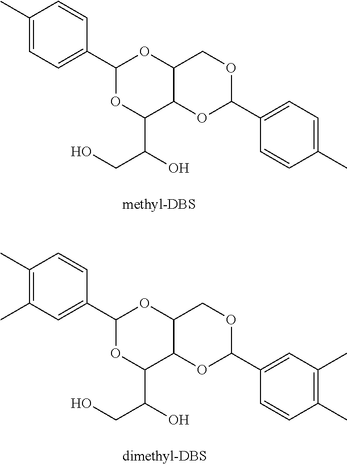

Recently, a new DBS-type product known as NX8000 (CAS 882073-43-0) has been marketed by Milliken Chemical as a clarifying agent for plastics and its structure is shown below

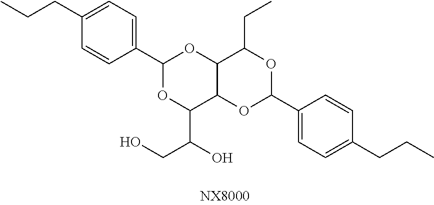

There are many other chemical analogs of DBS disclosed in the literature that generally have seen utility as polyolefin additives to enhance the clarity and aesthetics of plastics as disclosed, for example, in US 2007/0249850 A1, which is incorporated by reference herein.

DBS has now been found to be an effective rheology modifier in OD formulations of agrochemical products and offers improved performance and compatibility with the increasingly complex products being developed today. The present disclosure provides new methods and compositions for producing stable OD formulations of agrochemical products that are suitable in controlling undesired vegetation, insects and plant diseases, the inventive composition comprising a solvent, dibenzylidene sorbitol or an analog of dibenzylidene sorbitol, and an agricultural active ingredient.

### DETAILED DESCRIPTION OF THE INVENTION

The present invention relates to the use of dibenzylidene sorbitol or analogs of dibenzylidene sorbitol as rheology additives with improved performance to thicken or add viscosity to OD formulations containing agricultural active ingredients in order to increase the stability of such formulations, the composition comprising a solvent, at least one of dibenzylidene sorbitol and an analog of dibenzylidene sorbitol, and an agricultural active ingredient.

The solvent of the present disclosure is generally an organic, water immiscible solvent and may comprise one or more of petroleum distillates such as aromatic hydrocarbons derived from benzene, such as toluene, xylenes, other alkylated benzenes and the like, and naphthalene derivatives, aliphatic hydrocarbons such as hexane, octane, cyclohexane, and the like, mineral oils from the aliphatic or isoparaffinic series, and mixtures of aromatic and aliphatic hydrocarbons; halogenated aromatic or aliphatic hydrocarbons; vegetable, seed or animal oils such as soybean oil, rape seed oil, olive oil, castor oil, sunflower seed oil, coconut oil, corn oil, cotton seed oil, linseed oil, palm oil, peanut oil, safflower oil, sesame oil, tung oil and the like, and C₁-C₆ mono-esters derived from vegetable, seed or animal oils; dialkyl amides of short and long chain, saturated and unsaturated carboxylic acids; C₁-C₁₂ esters of aromatic carboxylic acids and dicarboxylic acids, and C₁-C₁₂ esters of aliphatic and cyclo-aliphatic carboxylic acids.

In addition, the above solvents may be mixed with one or more polar solvents such as, but not limited to, ethers like tetrahydrofuran and the like, alkylene glycol mono- or dialkyl ethers such as ethylene glycol monoethyl ether and the like, amides such as dimethylacetamide or N-methylpyrrolidone and the like, ketones such as methylethyl ketone and the like, nitriles such as butyronitrile and the like, sulfoxides or sulfones such as dimethyl sulfoxide or sulfolane and the like, mono- or polyhydric alcohols having 2 to 12 carbon atoms, and alkylene carbonates such as propylene or butylene carbonate and the like.

The solvent of the present disclosure may comprise, with respect to the total composition, from about 200 g/L to 999 g/L, preferably from about 300 g/L to 950 g/L.

The DBS of the present disclosure is used as a rheology additive to build viscosity in agrochemical OD formations thru formation of a gel. This helps keep the dispersed active ingredient suspended in the solvent and inhibits settling and sedimentation of the active ingredient which can contribute to formulation instability and inferior performance of the product. DBS may be dispersed and properly activated in the solvent prior to the addition of other components. The resulting mixture containing the activated DBS in the form of a gel generally shows good shear thinning properties. DBS may comprise, with respect to the total composition, from about 0.1 g/L to 100 g/L, preferably from about 0.1 g/L to 50 g/L.

As a further embodiment of the present disclosure, DBS may be used in combination with one or more existing rheology additives that are commonly used in agrochemical OD formulations to provide improved physical stability by inhibiting sedimentation. Suitable rheology additives to use with DBS may comprise one or more of a clay, a modified clay, a silica or a fumed silica, a hydrogenated castor oil, a castor oil derivative, a polyamide and a polyester. The DBS used in a combination with suitable rheology additives may comprise, with respect to the total composition, from about 0.1 g/L to 100 g/L, preferably from about 0.1 g/L to 50 g/L. The suitable rheology additives used in combination with DBS may comprise, with respect to the total composition, from about 0.1 g/L to 200 g/L, preferably from about 0.2 g/L to 100 g/L.

As a further embodiment of the present disclosure, analogs of DBS may be used alone, in combination with DBS, or in combination with one or more existing rheology additives used in agricultural OD formulations to provide physical stability by increasing the viscosity of such formulations. These analogs may comprise the following structures

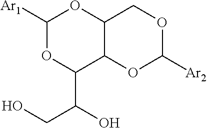

wherein Ar₁ and Ar₂ are the same or different mono- or polysubstituted phenyl rings groups. The substituted phenyl groups may contain one or more substituents selected from, but not limited to, C₁-C₁₀ alkyl, C₁-C₁₀ haloalkyl, C₁-C₁₀ alkoxy, C₁-C₁₀ haloalkoxy, C₁-C₁₀ alkylthio, C₁-C₁₀ haloalkylthio, C₁-C₁₀ haloalkylsulfinyl, C₁-C₁₀ haloalkyl-sulfonyl, hydroxyl, halo, nitro, carboxylic acid and derivatives thereof, cyano, amino, C₁-C₁₀ alkylamino, C₁-C₁₀ dialkylamino, C₁-C₁₀ alkylcarbonylamino, phenylcarbonylamino, C₁-C₁₀ alkylphenylcarbonylamino, C₁-C₁₀ alkylsulfonylamino and phenylsulfonylamino.

The agrochemical active ingredients of the present disclosure may be selected from the groups of herbicides, insecticides and fungicides. The active ingredients may be present as dispersed solids that have very low solubility in the solvent or they may be completely soluble or partially soluble in the solvent. Preferred dispersible active ingredients are generally higher melting solids (>50° C.) with low solubility (<10 g/L) in the solvent phase. Preferred soluble or partially soluble active ingredients are generally lower melting solids (<150° C.) with moderate to high solubility in the solvent phase (>10 g/L).

The dispersed solid herbicide active ingredients of the present invention include, but are not limited to sulfonamides, sulfonylureas, arylpyridine carboxylic acids and analogs, arylpyrimidine carboxylic acids and analogs, anilides, imidazolinones and carbazones. Also, alkali metal salts or amine salts of benzoic acids, phenoxyalkanoic acids, pyridinecarboxylic acids and pyridyloxycarboxylic acid herbicides may also comprise the dispersed active ingredients of the present invention.

Herbicides which are especially suitable for dispersion in the solvent phase are triasulfuron, tribenuron, metasulfuron, thifensulfuron, flupyrsulfuron, iodosulfuron, rimsulfuron, nicosulfuron, cinosulfuron, bensulfuron, trifloxysulfuron, foramsulphuron, mesosulphuron, sulphosulphuron, tritosulphuron and derivatives, furthermore flumetsulam, metosulam, chloransulam, florasulam, diclosulam, penoxsulam, pyroxsulam and derivatives, diflufenican, also imazethabenz, imazethapyr, imazaquin, imazamox and derivatives, and flucarbazone, propoxycarbazone, amicarbazone and derivatives, and compounds of the following generic structures, or their derivatives,

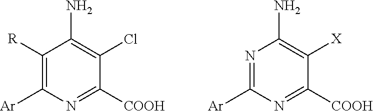

as disclosed in U.S. Pat. No. 7,314,849 B2 and U.S. Pat. No. 7,300,907 B2 wherein Ar is a polysubstituted phenyl group, R is H or halo and X is halo.

Additional herbicides which are especially suitable for dispersion in the solvent phase are alkali metal or amine salts of dicamba, 2,4-D, MCPA, 2,4-DB, aminopyralid, picloram, clopyralid, fluroxypyr and triclopyr, and alkali metal salts of bromoxynil and ioxynil. The amines are comprised of primary, secondary or tertiary alkylamines, alkanolamines, alkylalkanolamines or alkoxyalkanolamines wherein the alkyl and alkanol groups are saturated and contain C₁-C₄ alkyl groups individually. The alkali metals are comprised of sodium and potassium.

For an OD formulation of the present disclosure which may be further diluted at the point of use, the solvent dispersible herbicide may comprise, with respect to the total composition, from about 1 g/L to 700 g/L, preferably from about 5 g/L to 500 g/L. It is commonly known that this concentrated formulation may be diluted from 1 to 2000 fold at point of use depending on the agricultural practices.

A further embodiment of the present disclosure comprises the addition of solvent soluble or partially solvent soluble active ingredients and safeners. These active ingredients and safeners may include one or more of a herbicide, an insecticide, a fungicide and a herbicide safener, but are not limited to, esters of carboxylate, phosphate, or sulfate pesticides.

Suitable soluble or partially soluble herbicide active ingredients of the present invention include, but are not limited to benzoic acid herbicides such as dicamba esters, phenoxyalkanoic acid herbicides such as 2,4-D, MCPA or 2,4-DB esters, aryloxyphenoxypropionic acid herbicides such as clodinafop, cyhalofop, fenoxaprop, fluazifop, haloxyfop and quizalofop esters, pyridinecarboxylic acid herbicides such as aminopyralid, picloram and clopyralid esters, pyridyloxycarboxylic acids such as fluroxypyr and triclopyr esters, and nitrile herbicides such as bromoxynil and ioxynil and esters thereof.

Suitable soluble or partially soluble herbicide safeners of the present disclosure may comprise, but are not limited to, cloquintocet mexyl, benoxacor, cyometrinil, cyprosulfamide, dichlormid dicyclonon, dietholate, fenchlorazole ethyl, fenclorim, flurazole, fluxofenim, furilazole, isoxadifen ethyl, mefenpyr diethyl, mephenate, naphthalic anhydride, oxabetrinil and derivatives and analogs thereof.

The solvent soluble or partially solvent soluble herbicide active ingredients or herbicide safeners of the present invention may comprise, with respect to the total composition, from about 1 g/L to 700 g/L, preferably from about 5 g/L to 500 g/L.

Additional agricultural active ingredients of the present disclosure may include insecticides and fungicides. These active ingredients may be present as dispersed solids, or soluble or partially soluble active ingredients.

Suitable insecticide active ingredients of the present disclosure include, but are not limited to, antibiotic insecticides, macrocyclic lactone insecticides (for example, avermectin insecticides, milbemycin insecticides, and spinosyn insecticides), arsenical insecticides, botanical insecticides, carbamate insecticides (for example, benzofuranyl methylcarbamate insecticides, dimethylcarbamate insecticides, oxime carbamate insecticides, and phenyl methylcarbamate insecticides), diamide insecticides, desiccant insecticides, dinitrophenol insecticides, fluorine insecticides, formamidine insecticides, fumigant insecticides, inorganic insecticides, insect growth regulators (for example, chitin synthesis inhibitors, juvenile hormone mimics, juvenile hormones, moulting hormone agonists, moulting hormones, moulting inhibitors, precocenes, and other unclassified insect growth regulators), nereistoxin analogue insecticides, nicotinoid insecticides (for example, nitroguanidine insecticides, nitromethylene insecticides, and pyridylmethylamine insecticides), organochlorine insecticides, organophosphorus insecticides, oxadiazine insecticides, oxadiazolone insecticides, phthalimide insecticides, pyrazole insecticides, pyrethroid insecticides, pyrimidinamine insecticides, pyrrole insecticides, tetramic acid insecticides, tetronic acid insecticides, thiazole insecticides, thiazolidine insecticides, thiourea insecticides, urea insecticides, as well as, other unclassified insecticides.

Some of the particular insecticides that can be employed beneficially in combination with the invention disclosed in this document include, but are not limited to, the following 1,2-dichloropropane, 1,3-dichloropropene, abamectin, acephate, acetamiprid, acethion, acetoprole, acrinathrin, acrylonitrile, alanycarb, aldicarb, aldoxycarb, aldrin, allethrin, allosamidin, allyxycarb, alpha-cypermethrin, alpha-endosulfan, amidithion, aminocarb, amiton, amitraz, anabasine, athidathion, azadirachtin, azamethiphos, azinphos-ethyl, azinphos-methyl, azothoate, barium hexafluorosilicate, barthrin, bendiocarb, benfuracarb, bensultap, beta-cyfluthrin, beta-cypermethrin, bifenthrin, bioallethrin, bioethanomethrin, biopermethrin, bioresmethrin, bistrifluron, borax, boric acid, boric acid, bromfenvinfos, bromocyclen, bromo-DDT, bromophos, bromophos-ethyl, bufencarb, buprofezin, butacarb, butathiofos, butocarboxim, butonate, butoxycarboxim, cadusafos, calcium arsenate, calcium polysulfide, camphechlor, carbanolate, carbaryl, carbofuran, carbon disulfide, carbon tetrachloride, carbophenothion, carbosulfan, cartap, chlorantraniliprole, chlorbicyclen, chlordane, chlordecone, chlordimeform, chlorethoxyfos, chlorfenapyr, chlorfenvinphos, chlorfluazuron, chlormephos, chloroform, chloropicrin, chlorphoxim, chlorprazophos, chlorpyrifos, chlorpyrifos-methyl, chlorthiophos, chromafenozide, cinerin I, cinerin II, cismethrin, cloethocarb, closantel, clothianidin, copper acetoarsenite, copper arsenate, copper naphthenate, copper oleate, coumaphos, coumithoate, crotamiton, crotoxyphos, crufomate, cryolite, cyanofenphos, cyanophos, cyanthoate, cyantraniliprole, cyclethrin, cycloprothrin, cyfluthrin, cyhalothrin, cypermethrin, cyphenothrin, cyromazine, cythioate, DDT, decarbofuran, deltamethrin, demephion, demephion-O, demephion-S, demeton, demeton-methyl, demeton-O, demeton-O-methyl, demeton-S, demeton-S-methyl, demeton-S-methylsulphon, diafenthiuron, dialifos, diatomaceous earth, diazinon, dicapthon, dichlofenthion, dichlorvos, dicresyl, dicrotophos, dicyclanil, dieldrin, diflubenzuron, dilor, dimefluthrin, dimefox, dimetan, dimethoate, dimethrin, dimethylvinphos, dimetilan, dinex, dinoprop, dinosam, dinotefuran, diofenolan, dioxabenzofos, dioxacarb, dioxathion, disulfoton, dithicrofos, d-limonene, DNOC, doramectin, ecdysterone, emamectin, EMPC, empenthrin, endosulfan, endothion, endrin, EPN, epofenonane, eprinomectin, esfenvalerate, etaphos, ethiofencarb, ethion, ethiprole, ethoate-methyl, ethoprophos, ethyl formate, ethyl-DDD, ethylene dibromide, ethylene dichloride, ethylene oxide, etofenprox, etrimfos, EXD, famphur, fenamiphos, fenazaflor, fenchlorphos, fenethacarb, fenfluthrin, fenitrothion, fenobucarb, fenoxacrim, fenoxycarb, fenpirithrin, fenpropathrin, fensulfothion, fenthion, fenthion-ethyl, fenvalerate, fipronil, flonicamid, flubendiamide, flucofuron, flucycloxuron, flucythrinate, flufenerim, flufenoxuron, flufenprox, fluvalinate, fonofos, formetanate, formothion, formparanate, fosmethilan, fospirate, fosthietan, furathiocarb, furethrin, gamma-cyhalothrin, gamma-HCH, halfenprox, halofenozide, HCH, HEOD, heptachlor, heptenophos, heterophos, hexaflumuron, HHDN, hydramethylnon, hydrogen cyanide, hydroprene, hyquincarb, imidacloprid, imiprothrin, indoxacarb, iodomethane, IPSP, isazofos, isobenzan, isocarbophos, isodrin, isofenphos, isoprocarb, isoprothiolane, isothioate, isoxathion, ivermectin, jasmolin I, jasmolin II, jodfenphos, juvenile hormone I, juvenile hormone II, juvenile hormone III, kelevan, kinoprene, lambda-cyhalothrin, lead arsenate, lepimectin, leptophos, lindane, lirimfos, lufenuron, lythidathion, malathion, malonoben, mazidox, mecarbam, mecarphon, menazon, mephosfolan, mercurous chloride, mesulfenfos, metaflumizone, methacrifos, methamidophos, methidathion, methiocarb, methocrotophos, methomyl, methoprene, methoxychlor, methoxyfenozide, methyl bromide, methylchloroform, methylene chloride, metofluthrin, metolcarb, metoxadiazone, mevinphos, mexacarbate, milbemectin, milbemycin oxime, mipafox, mirex, monocrotophos, morphothion, moxidectin, naftalofos, naled, naphthalene, nicotine, nifluridide, nitenpyram, nithiazine, nitrilacarb, novaluron, noviflumuron, omethoate, oxamyl, oxydemeton-methyl, oxydeprofos, oxydisulfoton, para-dichlorobenzene, parathion, parathion-methyl, penfluron, pentachlorophenol, permethrin, phenkapton, phenothrin, phenthoate, phorate, phosalone, phosfolan, phosmet, phosnichlor, phosphamidon, phosphine, phoxim, phoxim-methyl, pirimetaphos, pirimicarb, pirimiphos-ethyl, pirimiphos-methyl, potassium arsenite, potassium thiocyanate, pp′-DDT, prallethrin, precocene I, precocene II, precocene III, primidophos, profenofos, profluthrin, promacyl, promecarb, propaphos, propetamphos, propoxur, prothidathion, prothiofos, prothoate, protrifenbute, pyraclofos, pyrafluprole, pyrazophos, pyresmethrin, pyrethrin I, pyrethrin II, pyridaben, pyridalyl, pyridaphenthion, pyrifluquinazon, pyrimidifen, pyrimitate, pyriprole, pyriproxyfen, quassia, quinalphos, quinalphos-methyl, quinothion, rafoxanide, resmethrin, rotenone, ryania, sabadilla, schradan, selamectin, silafluofen, silica gel, sodium arsenite, sodium fluoride, sodium hexafluorosilicate, sodium thiocyanate, sophamide, spinetoram, spinosad, spiromesifen, spirotetramat, sulcofuron, sulfoxaflor, sulfluramid, sulfotep, sulfuryl fluoride, sulprofos, tau-fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetramethrin, tetramethylfluthrin, theta-cypermethrin, thiacloprid, thiamethoxam, thicrofos, thiocarboxime, thiocyclam, thiodicarb, thiofanox, thiometon, thiosultap, thuringiensin, tolfenpyrad, tralomethrin, transfluthrin, transpermethrin, triarathene, triazamate, triazophos, trichlorfon, trichlormetaphos-3, trichloronat, trifenofos, triflumuron, trimethacarb, triprene, vamidothion, vaniliprole, XMC, xylylcarb, zeta-cypermethrin, zolaprofos, and α-ecdysone.

Additionally, any combination of the above insecticides can be used.

Suitable fungicide active ingredients of the present disclosure may also be combined with other fungicides to form fungicidal mixtures and synergistic mixtures thereof. The fungicidal compounds of the present disclosure are often applied in conjunction with one or more other fungicides to control a wider variety of undesirable diseases. When used in conjunction with other fungicide(s), the presently claimed compounds may be formulated with the other fungicide(s), tank mixed with the other fungicide(s) or applied sequentially with the other fungicide(s). Such other fungicides may include 2-thiocyanatomethylthio)-benzothiazole, 2-phenylphenol, 8-hydroxyquinoline sulfate, ametoctradin, amisulbrom, antimycin, Ampelomyces quisqualis, azaconazole, azoxystrobin, Bacillus subtilis, benalaxyl, benomyl, benthiavalicarb-isopropyl, benzylaminobenzene-sulfonate (BABS) salt, bicarbonates, biphenyl, bismerthiazol, bitertanol, bixafen, blasticidin-S, borax, Bordeaux mixture, boscalid, bromuconazole, bupirimate, calcium polysulfide, captafol, captan, carbendazim, carboxin, carpropamid, carvone, chloroneb, chlorothalonil, chlozolinate, Coniothyrium minitans, copper hydroxide, copper octanoate, copper oxychloride, copper sulfate, copper sulfate (tribasic), cuprous oxide, cyazofamid, cyflufenamid, cymoxanil, cyproconazole, cyprodinil, dazomet, debacarb, diammonium ethylenebis-(dithiocarbamate), dichlofluanid, dichlorophen, diclocymet, diclomezine, dichloran, diethofencarb, difenoconazole, difenzoquat ion, diflumetorim, dimethomorph, dimoxystrobin, diniconazole, diniconazole-M, dinobuton, dinocap, diphenylamine, dithianon, dodemorph, dodemorph acetate, dodine, dodine free base, edifenphos, enestrobin, epoxiconazole, ethaboxam, ethoxyquin, etridiazole, famoxadone, fenamidone, fenarimol, fenbuconazole, fenfuram, fenhexamid, fenoxanil, fenpiclonil, fenpropidin, fenpropimorph, fentin, fentin acetate, fentin hydroxide, ferbam, ferimzone, fluazinam, fludioxonil, flumorph, fluopicolide, fluopyram, fluoroimide, fluoxastrobin, fluquinconazole, flusilazole, flusulfamide, flutianil, flutolanil, flutriafol, folpet, formaldehyde, fosetyl, fosetyl-aluminium, fuberidazole, furalaxyl, furametpyr, guazatine, guazatine acetates, GY-81, hexachlorobenzene, hexaconazole, hymexazol, imazalil, imazalil sulfate, imibenconazole, iminoctadine, iminoctadine triacetate, iminoctadine tris(albesilate), ipconazole, iprobenfos, iprodione, iprovalicarb, isoprothiolane, isopyrazam, isotianil, kasugamycin, kasugamycin hydrochloride hydrate, kresoxim-methyl, mancopper, mancozeb, mandipropamid, maneb, mepanipyrim, mepronil, mercuric chloride, mercuric oxide, mercurous chloride, metalaxyl, mefenoxam, metalaxyl-M, metam, metam-ammonium, metam-potassium, metam-sodium, metconazole, methasulfocarb, methyl iodide, methyl isothiocyanate, metiram, metominostrobin, metrafenone, mildiomycin, myclobutanil, nabam, nitrothal-isopropyl, nuarimol, octhilinone, ofurace, oleic acid (fatty acids), orysastrobin, oxadixyl, oxine-copper, oxpoconazole fumarate, oxycarboxin, pefurazoate, penconazole, pencycuron, penflufen, pentachlorophenol, pentachlorophenyl laurate, penthiopyrad, phenylmercury acetate, phosphonic acid, phthalide, picoxystrobin, polyoxin B, polyoxins, polyoxorim, potassium bicarbonate, potassium hydroxyquinoline sulfate, probenazole, prochloraz, procymidone, propamocarb, propamocarb hydrochloride, propiconazole, propineb, proquinazid, prothioconazole, pyraclostrobin, pyrametostrobin, pyraoxystrobin, pyrazophos, pyribencarb, pyributicarb, pyrifenox, pyrimethanil, pyroquilon, quinoclamine, quinoxyfen, quintozene, Reynoutria sachalinensis extract, sedaxane, silthiofam, simeconazole, sodium 2-phenylphenoxide, sodium bicarbonate, sodium pentachlorophenoxide, spiroxamine, sulfur, SYP-Z071, SYP-Z048, tar oils, tebuconazole, tebufloquin, tecnazene, tetraconazole, thiabendazole, thifluzamide, thiophanate-methyl, thiram, tiadinil, tolclofos-methyl, tolylfluanid, triadimefon, triadimenol, triazoxide, tricyclazole, tridemorph, trifloxystrobin, triflumizole, triforine, triticonazole, validamycin, valifenalate, valiphenal, vinclozolin, zineb, ziram, zoxamide, Candida oleophila, Fusarium oxysporum, Gliocladium spp., Phlebiopsis gigantea, Streptomyces griseoviridis, Trichoderma spp., (RS)—N-(3,5-dichlorophenyl)-2-(methoxymethyl)-succinimide, 1,2-dichloropropane, 1,3-dichloro-1,1,3,3-tetrafluoroacetone hydrate, 1-chloro-2,4-dinitronaphthalene, 1-chloro-2-nitropropane, 2-(2-heptadecyl-2-imidazolin-1-yl)ethanol, 2,3-dihydro-5-phenyl-1,4-dithi-ine 1,1,4,4-tetraoxide, 2-methoxyethylmercury acetate, 2-methoxyethylmercury chloride, 2-methoxyethylmercury silicate, 3-(4-chlorophenyl)-5-methylrhodanine, 4-(2-nitroprop-1-enyl)phenyl thiocyanateme, ampropylfos, anilazine, azithiram, barium polysulfide, Bayer 32394, benodanil, benquinox, bentaluron, benzamacril; benzamacril-isobutyl, benzamorf, binapacryl, bis(methylmercury)sulfate, bis(tributyltin)oxide, buthiobate, cadmium calcium copper zinc chromate sulfate, carbamorph, CECA, chlobenthiazone, chloraniformethan, chlorfenazole, chlorquinox, climbazole, copper bis(3-phenylsalicylate), copper zinc chromate, cufraneb, cupric hydrazinium sulfate, cuprobam, cyclafuramid, cypendazole, cyprofuram, decafentin, dichlone, dichlozoline, diclobutrazol, dimethirimol, dinocton, dinosulfon, dinoterbon, dipyrithione, ditalimfos, dodicin, drazoxolon, EBP, ESBP, etaconazole, etem, ethirim, fenaminosulf, fenapanil, fenitropan, fluotrimazole, furcarbanil, furconazole, furconazole-cis, furmecyclox, furophanate, glyodine, griseofulvin, halacrinate, Hercules 3944, hexylthiofos, ICIA0858, isopamphos, isovaledione, mebenil, mecarbinzid, metazoxolon, methfuroxam, methylmercury dicyandiamide, metsulfovax, milneb, mucochioric anhydride, myclozolin, N-3,5-dichlorophenyl-succinimide, N-3-nitrophenylitaconimide, natamycin, N-ethylmercurio-4-toluenesulfonanilide, nickel bis(dimethyldithiocarbamate), OCH, phenylmercury dimethyldithiocarbamate, phenylmercury nitrate, phosdiphen, prothiocarb; prothiocarb hydrochloride, pyracarbolid, pyridinitril, pyroxychlor, pyroxyfur, quinacetol; quinacetol sulfate, quinazamid, quinconazole, rabenzazole, salicylanilide, SSF-109, sultropen, tecoram, thiadifluor, thicyofen, thiochlorfenphim, thiophanate, thioquinox, tioxymid, triamiphos, triarimol, triazbutil, trichlamide, urbacid, XRD-563, and zarilamid, IK-1140, and any combinations thereof.

The insecticide or fungicide active ingredients of the present disclosure may comprise, with respect to the total composition, from about 1 g/L to 700 g/L, preferably from about 5 g/L to 500 g/L.

It is usually desirable to incorporate one or more surface-active agents into the compositions of the present invention. The surface-active agents can be anionic, cationic or nonionic in character and can be employed as emulsifying agents, wetting agents, suspending agents, or for other purposes. Surfactants conventionally used in the art of formulation and which may also be used in the present formulations are described, inter alia, in “McCutcheon's Detergents and Emulsifiers Annual”, MC Publishing Corp., Ridgewood, N.J., 1998 and in “Encyclopedia of Surfactants”, Vol. I-III, Chemical publishing Co., New York, 1980-81. Typical surface-active agents include salts of alkyl sulfates, such as diethanolammonium lauryl sulfate; alkylarylsulfonate salts, such as calcium dodecylbenzenesulfonate; alkylphenol-alkylene oxide addition products, such as nonylphenol-C₁₈ ethoxylate; alcohol-alkylene oxide addition products, such as tridecyl alcohol-C₁₆ ethoxylate; soaps, such as sodium stearate; alkylnaphthalene-sulfonate salts, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable oils such as soy bean oil, rape seed oil, olive oil, castor oil, sunflower seed oil, coconut oil, corn oil, cotton seed oil, linseed oil, palm oil, peanut oil, safflower oil, sesame oil, tung oil and the like; and esters of the above vegetable oils.

The composition of the present disclosure may optionally include one or more additional inert ingredients such as antifoam agents, adjuvants, stabilizers, fragrants, sequestering agents, neutralizing agents, buffers, corrosion inhibitors, dyes, odorants and other commonly used ingredients.

The effective amount of the OD formulation of the present disclosure to be employed in a typical agricultural application often depends upon, for example, the type of plants, the stage of growth of the plant, severity of environmental conditions, the weeds, insects or fungal pathogens to be controlled and application conditions. Typically, a plant in need of protection from weeds or insects, or disease pathogen control or elimination, is contacted with an amount of the OD formulation diluted in a carrier such as water that will provide an amount from about 1 to about 40,000 ppm, preferably from about 10 to about 20,000 ppm of the active ingredient. The contacting may be in any effective manner. For example, any exposed part of the plant, e.g., leaves or stems may be sprayed with the active ingredient in mixture with a suitable amount of a diluent or carrier such as water.

The aforementioned compositions of the present invention may be applied to the plant foliage or the soil or area adjacent to the plant. Additionally, the compositions of the present invention may be mixed with or applied with any combination of agricultural active ingredients such as herbicides, insecticides, bacteriocides, nematocides, miticides, biocides, termiticides, rodenticides, molluscides, arthropodicides, fertilizers, growth regulators, and pheromones.

In a typical procedure for preparing an OD formulation of the present invention, a pre-gel of DBS is first prepared by dispersing and activating the DBS in the solvent with shear mixing and heat. Following cooling to room temperature, the pre-gel of DBS is then added with mixing to a mixture previously formed by shear mixing the active ingredient and any other ingredients with the solvent.

An example of a stable OD formulation of the present disclosure in which sedimentation of the dispersed active ingredient is retarded by DBS comprises:
a) a solvent comprising, with respect to the total composition, from about 200 g/L to about 999 g/L of Aromatic 200ND;
b) a rheology additive comprising, with respect to the total composition, from about 0.1 g/L to about 100 g/L of dibenzylidene sorbitol;
c) an active ingredient comprising, with respect to the total composition, from about 1 g/L to about 200 g/L of pyroxsulam;
d) optionally, other inert formulation ingredients.

### EXAMPLES

In order to properly activate DBS, a 1.5% pre-gel solution of DBS in an aromatic solvent (e.g., Aromatic 200 naphthalene depleted from ExxonMobil) was made by dispersing 1.5 g of DBS into 98.5 g of Aromatic 200 under high shear, heating the mixture to 50-55° C. for 15 minutes, and cooling the mixture to room temperature under low shear mixing. The resulting mixture should be semi-clear to clear in appearance and show highly thixotropic gel properties.

The compositions of the present disclosure shown in Table 1 were prepared using the following procedure: 1) the amount of solvent shown in Table 1 was charged into a glass beaker equipped with a mechanic stirrer; 2) the 1.5% DBS pre-gel was added into the beaker under constant mixing; 3) the active ingredient was then added to the mixture; 4) the mixture was stirred until homogeneous and then sonicated for 10 minutes to furnish the test sample. All samples were stable to sedimentation after 24 hours at room temperature by visual inspection.

TABLE 1
Compositions of the present disclosure for evaluation of stability to
sedimentation.

| | | | | | 1.5% DBS |
|---|---|---|---|---|---|
| | | AI | | Solvent | in |
| Formulation | Active | amount, | | amount, | Aromatic |
| # | ingredient (AI) | g | Solvent | g | 200ND, g |
| 1 | florasulam | 0.2 | Aromatic | 10 | 10 |
| | | | 200ND | | |
| 2 | penoxsulam | 0.4 | Aromatic | 10 | 10 |
| | | | 200ND | | |
| 3 | pyroxsulam | 1 | Aromatic | 10 | 10 |
| | | | 200ND | | |
| 4 | fenbuconazole | 1 | Aromatic | 10 | 10 |
| | | | 200ND | | |
| 5 | imidcloprid | 2 | Aromatic | 10 | 10 |
| | | | 200ND | | |
| 6 | sulfoxaflor | 2 | Exxsol D- | 10 | 10 |
| | | | 110 | | |

As indicated in Table 2 below, samples 7 and 8 were prepared with the ingredients shown and by the following procedure. Aromatic 200ND was first charged into a glass beaker equipped with a mechanic stirrer. Bentone 38 powder was then added to the beaker under high shear to ensure complete dispersion of the powder. Tensiofix N9824HF and propylene carbonate were then added under constant mixing. Finally the 1.5% DBS pre-gel was added to the mixture to furnish sample 7. No DBS was added to sample 8. Both samples 7 and 8 were then packaged into 100 mL glass bottles for storage stability assessment. The samples were stored undisturbed at room temperature for seven months. The percentage of syneresis was measured visually in both samples and Formulation 7 showed 8.7% top clearing while Formulation 8 showed 57.1% top clearing. The effect of including DBS was evident by the differing amount of phase separation in each sample.

TABLE 2
Stability of OD formulations with and without added DBS to syneresis
after seven months storage at room temperature

| | Formulation 7 | Formulation 8 |
|---|---|---|
| Ingredient | Amount, g | Amount, g |
| Aromatic 200ND | 48 | 48 |
| Bentone 38 clay | 2 | 2 |
| Tensiofix N9824HF | 5 | 5 |
| Propylene Carbonate | 0.7 | 0.7 |
| 1.5% DBS pre-gel | 0.75 | 0.0 |
| % Syneresis (top | 8.7% | 57.1% |
| clearing) | | |

As indicated in Table 3 below, samples 9 and 10 were prepared with the ingredients shown and by the following procedure. Aromatic 200ND was first charged into a glass beaker equipped with a mechanic stirrer. The Bentone 34 powder was then added to the beaker under high shear to ensure complete dispersion of the powder. The Tensiofix surfactants and propylene carbonate were then added under constant mixing. The active ingredient pyroxsulam and safener cloquintocet-mexyl were added and fully dispersed with high shear nixing. The rest of the ingredients were then added in no particular order except that the DBS was added as the last ingredient as a 1.5% pre-gel in Aromatic 200ND to furnish formulation 10. Both samples were then packaged into glass bottles for storage stability assessments.

TABLE 3
Compositions of formulation samples 9 and 10.

| | Formulation 9 | Formulation 10 |
|---|---|---|
| Ingredient | Amount, g | Amount, g |
| Cloquintocet-mexyl | 9 | 9 |
| Pyroxsulam | 4.5 | 3 |
| Bentone 38 | 2 | |
| Bentone 34 | | 3 |
| DBS | 0.15 | 0.2 |
| Thixcin R | 0.05 | |
| Atlox 4912 | 1 | 1 |
| Tensiofix N9824HF | 8 | 6.3 |
| Tensiofix N9811HF | | 2.7 |
| Butylene carbonate | 10 | |
| Propylene carbonate | | 3 |
| Aromatic 200ND | Balance to 100 ml | Balance to 100 ml |
| | total volume | total volume |

Samples 9 and 10 were exposed to a variety of temperature conditions including 54° C. and 40° C. constant temperatures, and −10° C. 140° C. cycling over one day, in order to evaluate their storage stability. The chemical assays were measured after storage for 2 weeks and formulations 9 and 10 were found to be chemically stable with no loss of the active ingredient being detected under all storage conditions. The samples were also compared on the basis of their yield stress which is known to be an indicator of rheology structure strength and hence the stability of the formulations. The higher the yield stress value the stronger the gel strength and hence better formulation stability. The yield stress was measured using an AR1000 rheometer from TA Instruments equipped with a 4 mm cross-hatched plate. The viscosity-stress curve was obtained by running the steady state shear by operating the rheometer from the lowest torque possible with the equipment up to 10,000 micro Newton meters (μNm). The yield stress was then calculated by the software on the rheometer as the onset stress value measured in Pascals (Pa) to drive the sample to flow. The yield stress measurements of samples 9 and 10 are shown in Table 5. The results show that formulations 9 and 10 had very stable high yield stress values when subjected to a variety of storage conditions indicating a stable rheology structure was present in each formulation.

TABLE 5
Yield Stress Measurements of Formulations 9 and 10 after Storage

| | | | Yield stress | Yield stress |
|---|---|---|---|---|
| | | Yield stress | after | after |
| | | after | 8 weeks | 2 weeks |
| | Initial Yield | 2 weeks at | at 40° C., | at −10° C./ |
| | Stress, Pa | 54° C., Pa | Pa | 40° C., Pa |
| Formulation 9 | 2.3 | 2.3 | 2.2 | 2.0 |
| Formulation 10 | 1.8 | 2.3 | | 2.1 |

The pourability of a particular OD formulation is a measure of the amount of sedimentation that occurs over time and how resistant that sediment is to being poured from the container in which it is stored. The pourability value can be measured by use of CIPAC method MT 148.1, Pourability of Suspension Concentrates. In this method, the suspension concentrate is allowed to stand for a defined period of time and then subjected to a standardized pouring procedure. The amount of material remaining in the container after pouring is determined and reported as the wt % of material remaining in the container. The wt % of material remaining after pouring is known as the pourability value. A glass bottle containing a sample of Formulation 10 was allowed to stand at room temperature for 24 hours and then the contents of the bottle were poured out following CIPAC method MT 148.1. The residual amount of Formulation 10 remaining in the bottle after pouring was found to be 1.77 wt % of the original amount, thereby giving a pourability value of 1.77% for Formulation 10.

While the invention has been described with respect to a limited number of embodiments, the specific features of one embodiment should not be attributed to other embodiments of the invention. No single embodiment is representative of all aspects of the invention. In some embodiments, the compositions or methods may include numerous compounds or steps not mentioned herein. In other embodiments, the compositions or methods do not include, or are substantially free of, any compounds or steps not enumerated herein. Variations and modifications from the described embodiments exist. Finally, any number disclosed herein should be construed to mean approximate, regardless of whether the word “about” or “approximately” is used in describing the number. The appended embodiments and claims intend to cover all those modifications and variations as falling within the scope of the invention.

What is claimed:

1. A mixture comprising:
a) a solvent;
b) at least one of dibenzylidene sorbitol and analogs of dibenzylidene sorbitol; and
c) an agricultural active ingredient.

2. The composition of claim 1 further comprising ingredients selected from dispersing agents, emulsifying agents, wetting agents, antifoam agents, adjuvants and safeners.

3. The composition of claim 1 wherein the composition includes more than one thickening agent.

4. The composition of claim 3 wherein the thickening agent is one of a clay, a modified clay, a silica, a hydrogenated castor oil, a castor oil derivative, a polyamide and a polyester.

5. The composition of claim 1 wherein the agricultural active ingredient comprises one or more dispersed solids.

6. The composition of claim 5 wherein the dispersed solid is a herbicide from the chemical classes comprised of sulfonamides, sulfonylureas and derivatives, arylpyridine carboxylic acids and derivatives, arylpyrimidine carboxylic acids and derivatives, anilides, imidazolinones and carbazones.

7. The composition of claim 6 wherein the herbicide is at least one of or a derivative of one of pyroxsulam, florasulam, penoxsulam, diflufenican, thifensulfuron, tribenuron, mesosulfuron, clopyralid, aminopyralid, fluroxypyr, triclopyr, picloram and compounds of the following structures 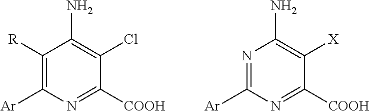
and their derivatives wherein Ar is a polysubstituted phenyl group, R is H or halo and X is halo.

8. The composition of claim 5 wherein the dispersed solid is a herbicide from the chemical classes comprised of alkali metal salts or amine salts of benzoic acids, phenoxyalkanoic acids, nitriles, pyridinecarboxylic acids and pyridyloxycarboxylic acids.

9. The composition of claim 8 wherein the herbicide is at least one of dicamba, 2,4-D, MCPA, 2,4-DB, aminopyralid, picloram, clopyralid, bromoxynil, ioxynil, fluroxypyr and triclopyr.

10. The composition of claim 1 wherein the agricultural active ingredient is at least one of an insecticide and a fungicide.

11. The composition of claim 1 wherein the agricultural active ingredient comprises at least one of a dissolved and a partially dissolved agricultural active ingredient.

12. The composition of claim 11 wherein the at least one of the dissolved and the partially dissolved agricultural active ingredient is at least one of a fluroxypyr ester, an MCPA ester, a 2,4-D ester, a bromoxynil derivative, an ioxynil derivative, a dicamba ester, a 2,4-DB ester, an aminopyralid ester, a picloram ester, a clopyralid ester, a triclopyr ester, a clodinafop ester, a cyhalofop ester, a fenoxaprop ester, a fluazifop ester, a haloxyfop ester and a quizalofop ester.

13. The composition of claim 1 further comprising a herbicide safener.

14. The composition of claim 13 wherein the herbicide safener is one of cloquintocet mexyl, benoxacor, cyometrinil, cyprosulfamide, dichlormid dicyclonon, dietholate, fenchlorazole ethyl, fenclorim, flurazole, fluxofenim, furilazole, isoxadifen ethyl, mefenpyr diethyl, mephenate, naphthalic anhydride and oxabetrinil, and analogs and derivatives thereof.

15. The composition of claim 1 utilized for controlling insects, plant diseases or weeds including the steps of:
providing a formulation including the composition of claim 1, and
diluting the formulation containing the composition of claim 1 in a suitable agricultural carrier such as water
applying at least one of a formulation including the composition of claim 1 to at least one of the plant, the area adjacent to the plant, plant foliage, blossoms, stems, fruits, soil, seeds, germinating seeds, roots, liquid and solid growth media, and hydroponic growth solutions.

16. A method of controlling insects, plant diseases or weeds including the steps of:
providing a formulation including the composition of claim 1, and
applying an agriculturally effective amount of the formulation in mixture with one or more conventional formulations of agricultural active ingredients or nutrients to at least one of the following: the plant, plant foliage, blossoms, stems, fruits, the area adjacent to the plant, soil, seeds, germinating seeds, roots, liquid and solid growth media, and hydroponic growth solutions.

17. An oil dispersion having a pourability value of less than 5%, the oil dispersion comprising:
a) a solvent;
b) one of dibenzylidene sorbitol and analogs of dibenzylidene sorbitol; and
c) an agricultural active ingredient

18. A non-aqueous suspension concentrate comprising:
a) a solvent;
b) one of dibenzylidene sorbitol and analogs of dibenzylidene sorbitol; and
c) an agricultural active ingredient
